(19) United States
(12) Patent Application Publication
(10) Pub. No.: US 2023/0319205 A1
(43) Pub. Date: Oct. 5, 2023

(54) DETERMINING THE SIZE OF A PRINT MEDIA

(71) Applicant: Hewlett-Packard Development Company, L.P., Spring, TX (US)

(72) Inventors: Aiqiang YANG, Singapore (SG); Kok Chai CHONG, Singapore (SG); Suriyaprakash SARAVANAN, Singapore (SG)

(21) Appl. No.: 18/023,432

(22) PCT Filed: Sep. 7, 2020
(86) PCT No.: PCT/US2020/049622

§ 371 Date: Feb. 27, 2023

(51) Int. Cl. H04N 1/00

(52) U.S. Cl. CPC H04N 1/00708; H04N 1/00694; H04N 1/00737; H04N 1/00761

(57) ABSTRACT

In one example, a device to transfer multiple first positions of an edge guide movable back and forth across a print media input tray to corresponding multiple second positions of an optical marker movable back and forth along a scan line next to a scan bed located near the input tray. The device includes a first part connected to or integral with the edge guide, a second part connected to or integral with the marker, and a mechanical link linking the first part and the second part to convert linear motion of the edge guide back and forth across the tray to linear motion of the marker back and forth along the scan line.

### BACKGROUND

In many desktop printers, sheets of paper or other print media used for printing are held in an input tray located close to the printing unit. The input tray includes at least one adjustable edge guide that helps keep the media properly aligned as it is fed into the printing unit. The user moves the edge guide back and forth across the tray to accommodate different size print media.

### DRAWINGS

FIG. 1 is a block diagram illustrating a printing and scanning device implementing an example of a print media size determination system.

FIG. 2 is a block diagram illustrating an example controller such as might be used in the printing and scanning device shown in FIG. 1.

FIG. 3 is a flow diagram illustrating an example of a method to automatically determine the size of the media in a printer input tray.

FIGS. 4 and 5 are isometric views illustrating a printing and scanning device implementing an example of a print media size determination system.

FIG. 6 is a plan view of the printing and scanning device shown in FIGS. 4 and 5.

FIG. 7 is a plan view of the printing and scanning device shown in FIGS. 4 and 5 with the scan bezel removed.

FIG. 8 is a detail from FIG. 7.

FIGS. 9 and 10 are isometric views illustrating an example of a scan bezel in the printing and scanning device shown in FIGS. 4 and 5.

FIGS. 11 and 12 are section views along the lines 11-11 and 12-12 in FIG.

FIG. 13 is a section view along the line 13-13 in FIG. 10.

FIG. 14 is an isometric view illustrating an example of a mechanical transfer device for the printing and scanning device shown in FIGS. 4 and 5.

FIGS. 15 and 16 are graphs illustrating example scan sensor readings.

The same part numbers refer to the same or similar parts throughout the figures. The figures are not necessarily to scale.

### DESCRIPTION

It may be desirable in some printing applications for the printer to automatically determine the size of print media in the input tray before printing. A new technique has been developed to use the scanning unit in an MFP (multi-function printer) to automatically determine the size of the print media in the input tray. Examples of the new technique may be implemented in MFPs with a flatbed scanning unit. While the scanning unit is parked next to the scan bed, and otherwise idle, the parked scanning unit is activated to sense the position of an optical marker along the scan line. The marker is connected to the edge guide in the input tray through a mechanical link that converts the position of the edge guide in the tray to a corresponding position of the marker along the scan line. When print media is loaded into the tray, the user positions the edge guide next to the media. Thus, the position of the edge guide in the tray and the corresponding position of the marker along the scan line indicates the size of the print media in the tray.

Accordingly, the MFP can determine the size of the print media from the position of the marker sensed by the parked scanning unit, for example using a look-up table or an algorithm that associates marker positions with corresponding media sizes. Examples of the new technique enable the determination of media sizes along a continuum that corresponds to the continuum of positions of an edge guide in the printer input tray. The scan resolution of a typical consumer MFP is sufficient to accurately differentiate among many common print media sizes.

The examples described herein illustrate but do not limit the scope of the patent which is defined in the Claims following this Description.

As used in this document: “and/or” means one or more the connected things; and a “computer readable medium” means any non-transitory tangible medium that can embody, contain, store, or maintain programming for use by a computer processor and may include, for example, circuits, integrated circuits, ASICs (application specific integrated circuits), hard drives, random access memory (RAM), read-only memory (ROM), and memory cards and sticks and other portable storage devices.

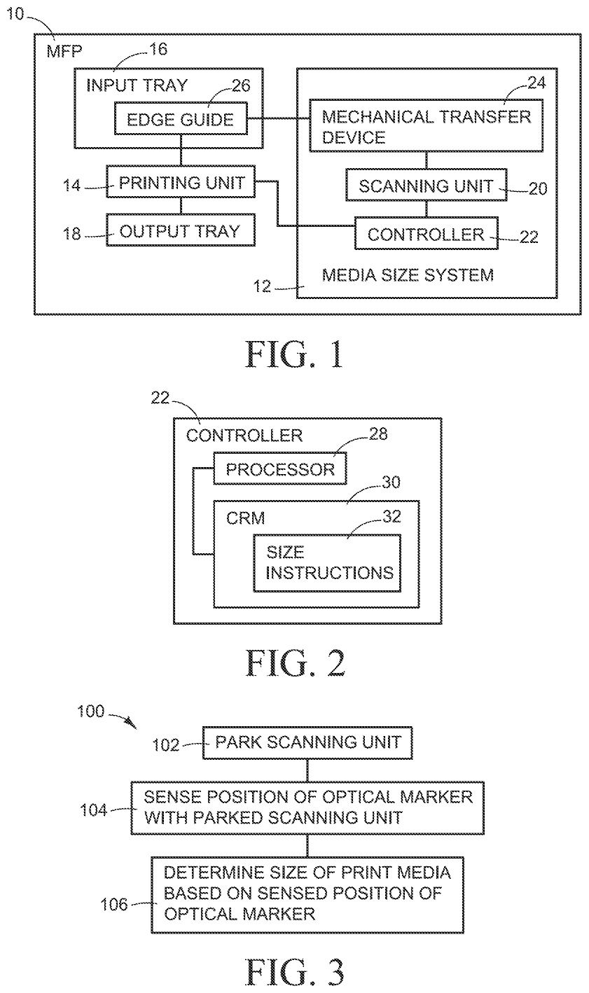

FIG. 1 is a block diagram illustrating a printing and scanning device 10 implementing an example of a media size determination system 12. For convenience, printing and scanning device 10 is referred to in the following description as MFP (multi-function printer) 10. MFP 10 includes a printing unit 14, an input tray 16 to hold media for input to printing unit 14, and an output tray 18 to receive printed media from printing unit 14. MFP 10 also includes a scanning unit 20 and a controller 22 operatively connected to printing and scanning units 14, 20.

Media size determination system 12 includes scanning unit 20, controller 22, and a mechanical position transfer device 24 connected to an adjustable edge guide 26 in input tray 16. Controller 22 represents the processing and memory resources, programming, and the electronic circuitry and components needed to control the operative components of MFP 10 and may include distinct control elements for individual components or groups of components. In particular, and referring to FIG. 2, controller 22 includes a processor 28 and a computer readable medium 30 with media size determination instructions 32.

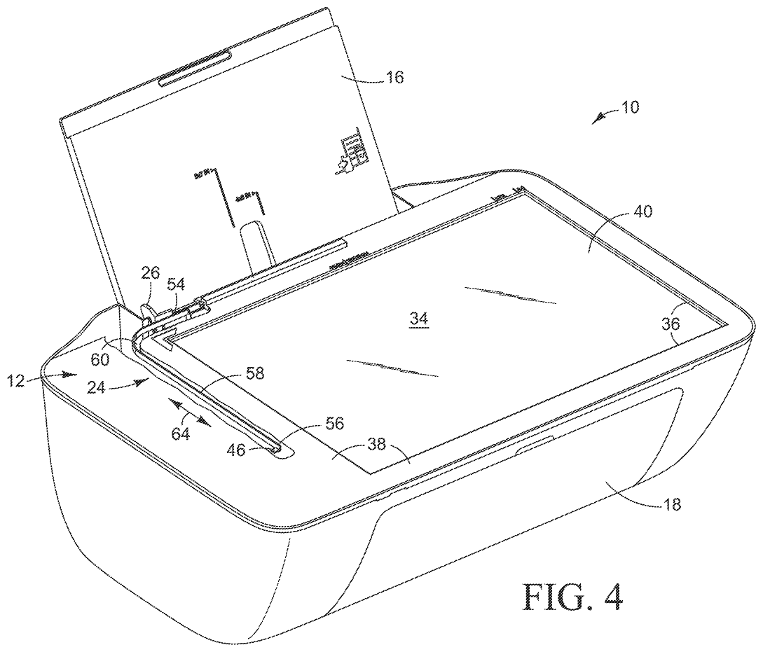

Edge guide 26 may be moved back and forth across input tray 16 to accommodate different size print media. When print media is loaded into tray 16, the user positions edge guide 26 close to or against one side of the media. Thus, the position of edge guide 26 represents the size of the media in tray 16. As explained in detail below with reference to FIGS. 4-10, transfer device 24 is configured to mechanically transfer the position of edge guide 26 in tray 16 to the position of an optical marker that moves back and forth along a scan line for scanning unit 20. Scanning unit 20 senses the position of the optical marker, and thus the position of edge guide 26, so that controller 22 can determine the size of the print media in tray 16.

FIG. 3 illustrates one example of a method 100 for an MFP 10 to automatically determine the size of print media in tray 16, such as might be implemented by a processor 28 in controller 22 executing size instructions 30. Referring to FIG. 3, method 100 includes parking a scanning unit 20 (block 102), for example at a location where the scanning unit would otherwise be idle, and sensing the position of an optical marker with the parked scanning unit 20 (block 104). As noted above, the position of the optical marker corresponds to the position of edge guide 26. Based on the position of the optical marker sensed by scanning unit 20, controller 22 determines the size of the print media in tray 16 (block 106), for example using a look-up table or algorithm that associates marker positions with corresponding media sizes.

In one example, the parked scanning unit 20 is activated in response to a print command to sense the position of the optical marker so that controller 22 can determine the size of print media in tray 16 before executing the print command. In another example, the parked scanning unit 20 is activated by a sensor sensing media loaded into tray 16, such as when an empty tray 16 is refilled or media in tray 16 is removed and replaced. In another example, the parked scanning unit 20 is activated periodically to sense the position of the optical marker so that controller 22 can monitor the size of print media in tray 16. The parked scanning unit 20 may be activated with sufficient frequency to detect any change in the position of the optical marker before printing. Loading a different size print media into tray 16 and adjusting the position of edge guide 26 changes the position of the optical marker along the scan line for the parked scanning unit 20, allowing controller 22 to detect the change and determine the new media size before printing on the new media. In one example, the parked scanning unit 20 is activated, and media size determined, at least every 1 second. It is expected that in many printing environments in which print media is loaded manually and printing initiated by the user, 1 second intervals will be sufficient to determine a new media size before printing, and thus enable accurate real time monitoring of the size of print media in tray 16.

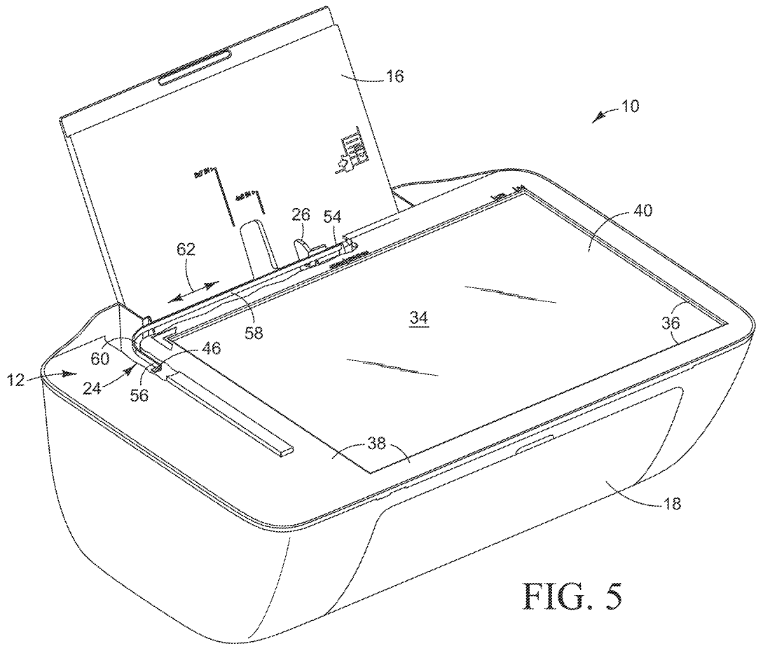

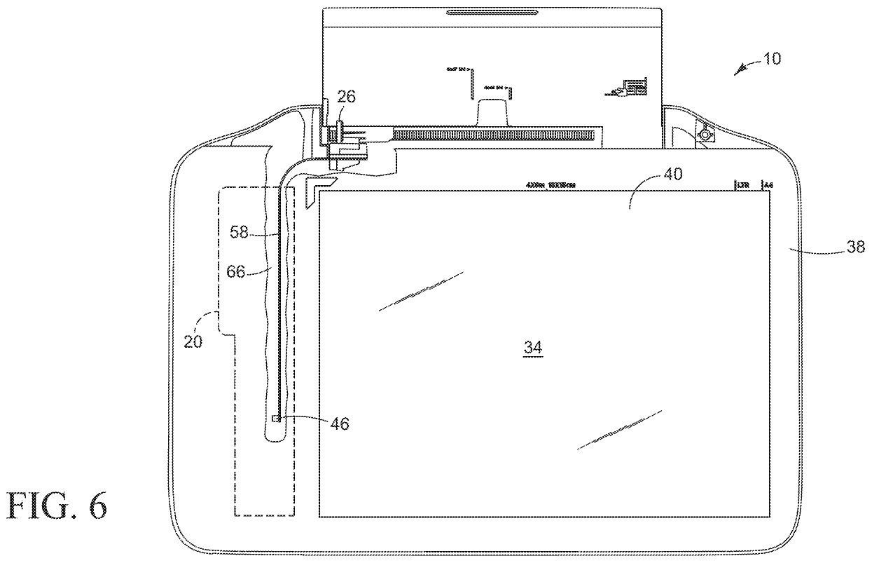

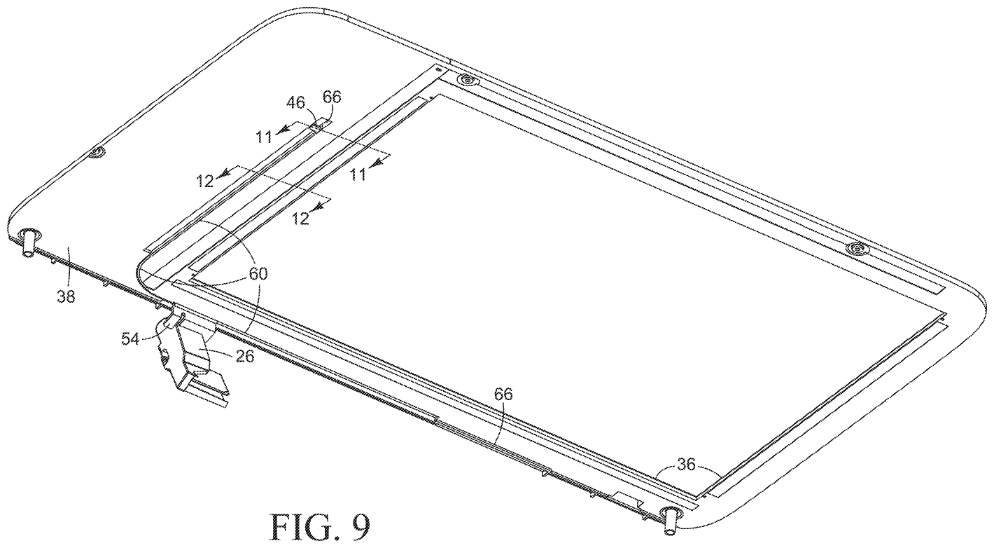

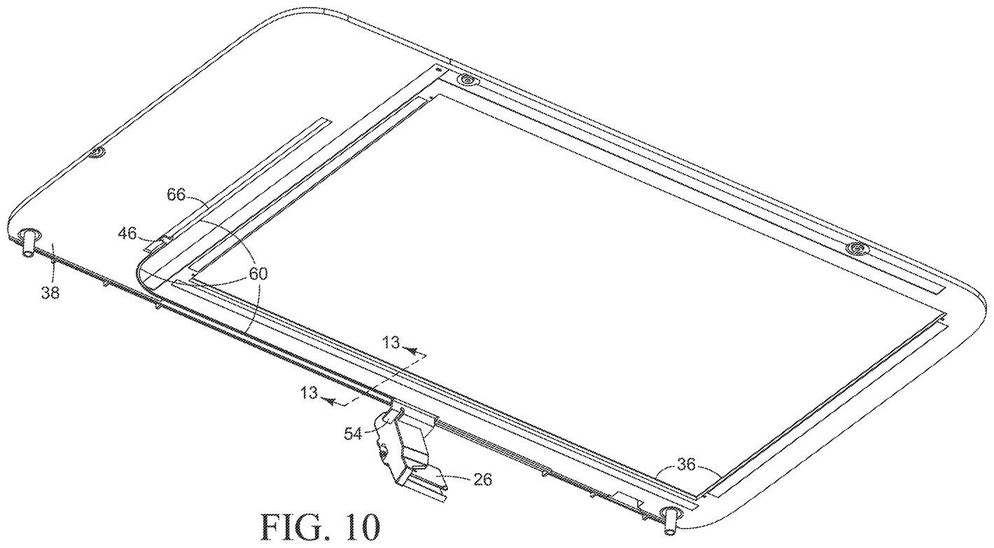

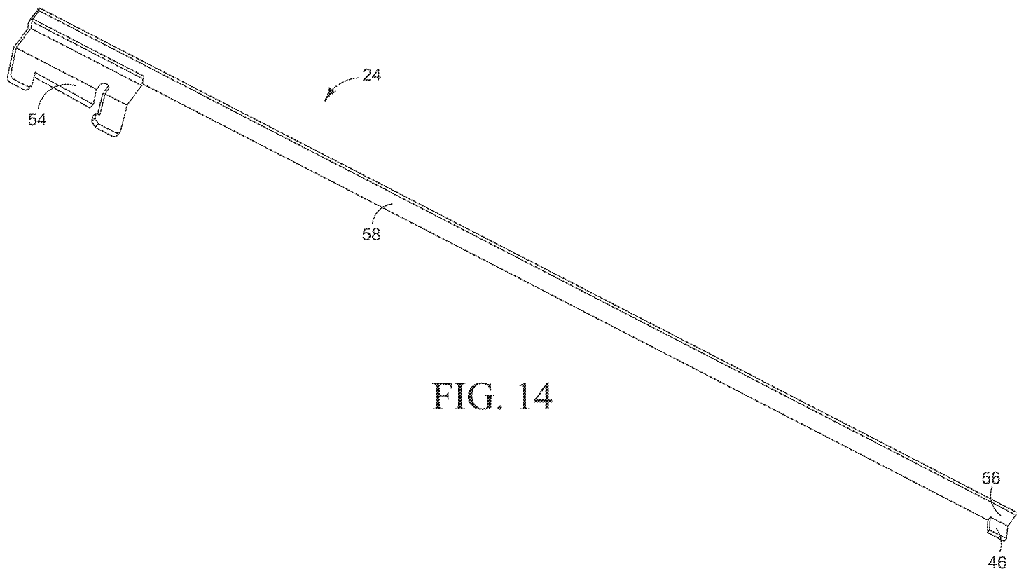

FIGS. 4 and 5 are isometrics illustrating an MFP 10 implementing an example of a media size determination system 12. FIG. 6 is a plan of the MFP 10 shown in FIGS. 4 and 5. FIG. 7 is a plan of the MFP 10 shown in FIGS. 4 and 5 with the scan bezel removed. FIGS. 9 and 10 are isometrics illustrating an example of a scan bezel in the MFP 10 shown in FIGS. 4 and 5. FIGS. 9 and 10 show the underside of the scan bezel. FIG. 14 is an isometric detail illustrating the mechanical transfer device 24 for the MFP shown in FIGS. 4 and 5.

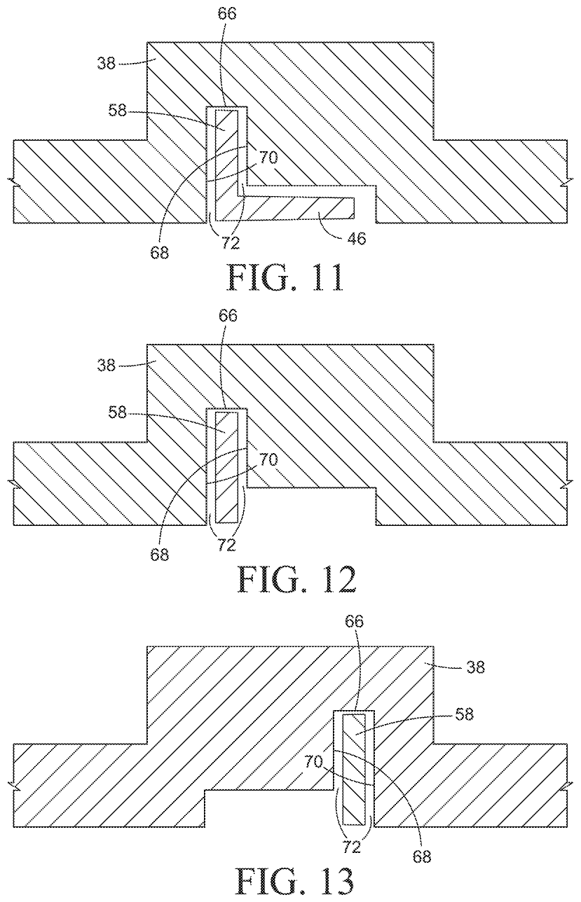

Referring to FIGS. 4-14, MFP 10 includes a printer input tray 16 from which print media is fed to a printing unit (not shown) for printing and a fold down output tray 18 to which printed media is discharged. Output tray 18 is shown folded up (closed) in FIGS. 4 and 5. MFP 10 also includes a flatbed scanner in which a movable scanning unit 20, seen in FIGS. 6-8, scans things on a flat bed 34. Scan bed 34 is defined by an opening 36 in an opaque bezel 38 on a transparent platen 40 that is mounted over the scanning unit. Part of bezel 38 is cut away in FIGS. 4-6 to show underlying features. Bezel 38 is omitted and part of platen 40 is cut away in FIG. 7 to show underlying features. A cover that opens and closes over scan bed 34 is omitted from all the figures.

As best seen by comparing FIGS. 4 and 5, an adjustable edge guide 26 slides back and forth across input tray 16 to accommodate different size print media. In FIG. 4, edge guide 26 is positioned for wider media, letter size media for example. In FIG. 5, edge guide 26 is positioned for narrower media, 3″×5″ media for example. Media size determination system 12 includes a scanning unit 20 (seen in FIGS. 6-8), a controller such as controller 22 shown in FIG. 2, and a mechanical position transfer device 24 connected to edge guide 26. Transfer device 24 is configured to transfer the position of edge guide 26 in tray 16 to the position of an optical marker 46 that moves back and forth along a scan line 48 for scanning unit 20.

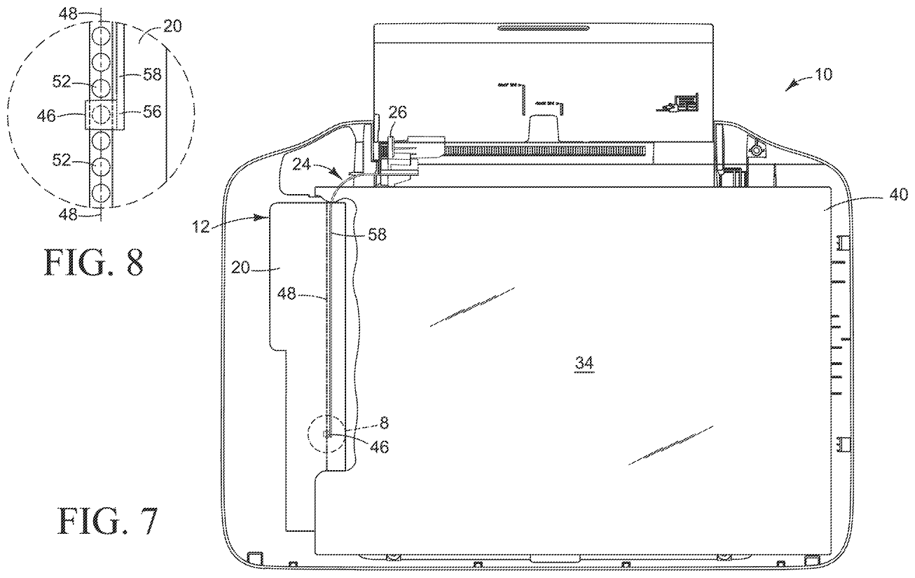

Scan line 48, shown in FIGS. 7 and 8, represents the sensing area for a so-called “line scan” scanning unit typical of flat bed scanners used in many MFPs. For example, and referring specifically to FIG. 8, a scanning unit 20 may use a single row of image sensors 52 to sense the position of marker 46 along scan line 48 while parked next to scan bed 34, and to sense things on scan bed 34 while moving under scan bed 34. An optical marker 46 is anything that can be sensed by an MFF scanning unit 20. Marker 46 may be implemented, for example, as a contrast in color and/or distance to that part of scan bezel 38 behind marker 46. For example, if bezel 38 is white behind marker 46, then marker 46 is dark. For another example, if bezel 38 is dark behind marker 46, then marker 46 is white. A color contrast label may be affixed to bezel 38 behind marker 46 to achieve the desired contrast. For another example, marker 46 and bezel 38 may be the same color if marker 46 is closer than bezel 38 to image sensors 52.

In the example shown in FIGS. 4-14, transfer device 24 includes a first part 54 connected to or integral with edge guide 26, a second part 56 connected to or integral with marker 46, and a mechanical link 58 linking first part 54 and second part 56. Transfer device 24 converts the linear motion of edge guide 26 back and forth across tray 16 to linear motion of marker 46 back and forth along scan line 48 along a continuum of positions that correspond to the continuum of positions of edge guide 26. In this example, as best seen in FIGS. 9 and 14, the first part 54 of transfer device 24 is a connector that attaches to edge guide 26 to connect edge guide 26 to link 58. In this example, as best seen in FIG. 14, marker 46 is an integral part of second part 56 of transfer device 24. In this example, marker 46 protrudes from second part 56 into a region over image sensors 52 along scan line 48. Although parts 54, 56 are located at opposite ends of link 58 in this example, other configurations are possible. For example, the ends of link 58 may extend beyond one or both parts 54, 56.

In this example, link 58 is a flexible link that follows a curved path 60 to convert the motion of edge guide 26 along a first line 62 (FIG. 5) to motion of marker 46 along a second line 64 (FIG. 4) orthogonal to first line 62. Path 60 is formed at least in part by a groove 66 with sidewalls 68, 70 in the underside of bezel 38, as best seen in FIGS. 9-13. The position of edge guide 26 in FIGS. 9 and 10 corresponds to the position of edge guide 26 in FIGS. 4 and 5, respectively. While it is expected that groove 66 usually will be implemented as a single continuous groove along path 60, other implementations are possible. For example, it may be desirable in some applications to implement groove 66 as a series of discrete groove segments that together support a flexible link 58 along path 60.

Certain configurations for groove 66 enable the use of inexpensive materials for link 58, and without changing the materials already commonly used for bezel 38. For example, for a molded ABS (acrylonitrile butadiene styrene) bezel 38, link 58 may be made from a sheet of PET (polyethylene terephthalate) if the clearance 72 between link 58 and sidewalls 68, 70 is sufficiently tight to prevent link 58 from giving way when pushing marker 46 over platen 40 along scan line 48. For example, testing indicates a 0.3 mm thick PET link 58 in a 1.3 mm wide groove 66 will not give way when pushing marker 46 along scan line 48. Other suitable material and geometric configurations are possible including, for example, a 1 mm thick molded POM (polyoxmethylene) link 58 can slide freely in groove 66 around a 23 mm radius curved part of path 60. POM sidewalls 68, 70 or POM coated sidewalls 68, 70 reduce friction along the curved part of path 60. Also, other suitable configurations for link 58 are possible including, for example, belts, gears, racks, linkages, and/or other transfer mechanisms.

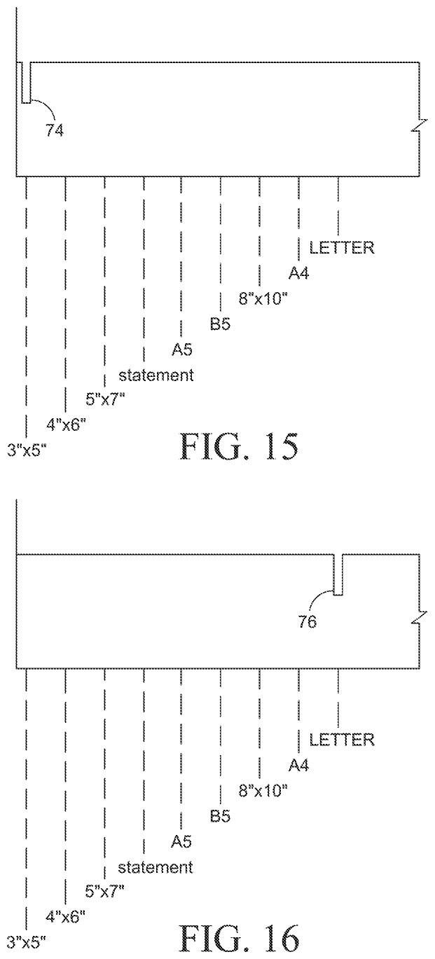

The graph in FIG. 15 illustrates one example of a scan sensor reading for the position of optical marker 46 in FIG. 4 corresponding to letter size print media in tray 16. Referring to FIG. 15, when scan unit 20 parked next to scan bed 34 is activated, sensors 52 sense marker 46 at a location 74 along scan line 48 corresponding to letter size media. The graph of FIG. 16 illustrates one example of a scan sensor reading for the position of marker 46 in FIG. 5 corresponding to 3″×5″ print media in tray 16. Referring to FIG. 16, when scan unit 20 parked next to scan bed 34 is activated, sensors 52 sense marker 46 at a location 76 along scan line 48 corresponding to 3″×5″ media. A controller 22 may determine the size of print media in tray 16 based on the position of marker 46 sensed by scanning unit 20, for example using an algorithm or a look-up table that associates the position of marker 46 with the corresponding media size.

The examples shown in the figures and described above illustrate but do not limit the patent, which is defined in the following Claims.

“A” and “an” used in the claims means one or more. For example, “a mechanical link” means one or more mechanical links and subsequent reference to “the link” means the one or more mechanical links.

1. A device to transfer multiple first positions of an edge guide movable back and forth across a print media input tray to corresponding multiple second positions of an optical marker movable back and forth along a scan line next to a scan bed located near the input tray, the device comprising:
a first part connected to or integral with the edge guide;
a second part connected to or integral with the marker; and
a mechanical link linking the first part and the second part to convert linear motion of the edge guide back and forth across the tray to linear motion of the marker back and forth along the scan line.

2. The device of claim 1, wherein:
the link comprises a flexible link; and
the device comprises a sidewall on each side of the link to prevent the link from giving way when pushing the marker along the scan line.

3. The device of claim 2, wherein the sidewalls are configured to guide the link along a curved path to convert motion of the edge guide along a first line to motion of the marker along a second line orthogonal to the first line.

4. The device of claim 3, comprising:
a bezel at least partially surrounding the scan bed; and
a groove in the bezel, the sidewalls defining at least part of the groove.

5. The device of claim 4, wherein the marker protrudes from the second part of the link into a region along the scan line over a scan module parked next to the scan bed.

6. The device of claim 5, wherein the multiple first positions include a continuum of multiple first positions and the multiple second positions include a continuum of corresponding multiple second positions.

7. A computer readable medium having instructions thereon that when executed cause a printing and scanning device to:
park a scanning unit;
using the parked scanning unit, sense a position of a marker along a scan line; and
based on the sensed position, determine a size of a print media.

8. The medium of claim 7, wherein:
the instructions to sense comprise instructions to:
using the parked scanning unit, sense a first position of the marker along the scan line; and
using the parked scanning unit, sense a second position of the marker along the scan line different from the first position; and
the instructions to determine comprise instructions to:
based on the sensed first position, determine a first size of a first print media; and
based on the sensed second position, determine a second size of a second print media different from the first size.

9. The medium of claim 7, comprising instructions to periodically activate the parked scanning unit and wherein:
the instructions to sense comprise instructions to sense the position of the marker along the scan line each time the parked scanning unit is activated; and
the instructions to determine comprise instructions to, based on each of the sensed positions, determine the size of a print media.

10. The medium of claim 9, wherein the instructions to periodically activate the parked scanning unit comprise instructions to periodically activate the parked scanning unit at least every 1 second.

11. A method for a printing and scanning device having a tray to hold print media for printing, the method comprising:
parking a scanning unit next to one side of a scan bed;
using the parked scanning unit, sensing a position of a marker along a scan line; and
based on the sensed position, determining a size of a print media in the tray.

12. The method of claim 11, wherein:
the sensing comprises:
using the parked scanning unit, sensing a first position of the marker along the scan line; and
using the parked scanning unit, sensing a second position of the marker along the scan line different from the first position; and
the determining comprises:
based on the sensed first position, determining a first size of a first print media in the tray; and
based on the sensed second position, determining a second size of a second print media in the tray different from the first size.

13. The method of claim 11, comprising periodically activating the parked scanning unit and wherein:
the sensing comprises sensing the position of the marker along the scan line each time the parked scanning unit is activated; and
the determining comprises, based on each of the sensed positions, determining the size of a print media in the tray.

14. The method of claim 13, wherein periodically activating the parked scanning unit comprises activating the parked scanning unit at least every 1 second.
